(19) United States
(12) Patent Application Publication
(10) Pub. No.: US 2017/0337597 A1
(43) Pub. Date: Nov. 23, 2017

(54) METHOD AND SYSTEM OF RANKING AN ACCOMMODATION

(71) Applicant: Samuel Gaita, North Bay Village, FL (US)

(72) Inventor: Samuel Gaita, North Bay Village, FL (US)

(21) Appl. No.: 15/601,791

(22) Filed: May 22, 2017

Related U.S. Application Data
(60) Provisional application No. 62/339,588, filed on May 20, 2016.

(51) Int. Cl. G06Q 30/02; G06K 9/00; G06F 17/30; G06Q 50/12; G06Q 10/06

(52) U.S. Cl. CPC G06Q 30/0282; G06Q 50/12; G06Q 10/06395; G06F 17/30047; G06K 9/00671; G06K 9/00691

(57) ABSTRACT

Disclosed is a method of ranking an accommodation. The method includes receiving, using a processor, an identifier associated with the accommodation. The method further includes receiving, using the processor, multiple object identifiers corresponding to multiple objects comprised in the accommodation. Further, the method includes receiving, using the processor, one or more values corresponding to one or more attributes associated with each object of the multiple objects. Moreover, the method includes analyzing, using the processor, the one or more values. Yet further, the method includes generating, using the processor, a rank associated with the accommodation based on the analyzing of the one or more values. Furthermore, the method includes storing, using a storage device, each of the rank and the identifier associated with the accommodation.

### FIELD OF THE INVENTION

The present invention relates to a ranking system. In particular, the present invention relates to a method and a system of ranking accommodations.

### BACKGROUND OF THE INVENTION

Accommodations such as vacation residences are often rented out to individuals or families for short or extended periods of time, functioning as an alternative to hotels. The vacation residences may include furnished apartments, houses, or resort condominiums. While many hotels are nice, they are often small and not suited for stays which last longer than a few days. Therefore, the use of vacation residences is becoming popular, especially for those willing to spend a little extra.

However, it is common for travelers to experience disappointment at their vacation residences when the residences do not live up to their pre-conceived levels of quality. For example, travelers often complain that travel websites misrepresent a listed accommodation, such as by displaying outdated photos. However, at the time of the travel the vacation residence may have old furnishings, unattractive amenities, broken facilities, and may suffer from more problems.

Therefore, there is a need for methods and systems to rank accommodations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a method of ranking an accommodation. The method includes receiving, using a processor, an identifier associated with the accommodation. The method further includes receiving, using the processor, multiple object identifiers corresponding to multiple objects comprised in the accommodation. Further, the method includes receiving, using the processor, one or more values corresponding to one or more attributes associated with each object of the multiple objects. Moreover, the method includes analyzing, using the processor, the one or more values. Yet further, the method includes generating, using the processor, a rank associated with the accommodation based on the analyzing of the one or more values. Furthermore, the method includes storing, using a storage device, each of the rank and the identifier associated with the accommodation.

According to some embodiments, a system for ranking an accommodation is disclosed. The system includes a communication device configured to receive an identifier associated with the accommodation, receive multiple object identifiers corresponding to multiple objects comprised in the accommodation, and receive one or more values corresponding to one or more attributes associated with each object of the multiple objects. Further, the system includes a processing device configured to analyze the one or more values and generate a rank associated with the accommodation based on the analyzing of the one or more values. Moreover, the system includes a storage device configured to store each of the rank and the identifier associated with the accommodation.

According to some embodiments, the present disclosure relates to a system of classifying luxury vacation residences with a proprietary ranking method and classification levels. The managers of the disclosed system use a best-in-class inspection team that travels the globe to meticulously screen each accommodation. Only the best accommodations make it into an accommodation collection. After examination by an inspector, an accommodation may be inducted into the accommodation collection upon meeting minimum standards or criteria which may be set by the managers of the disclosed system. Additional features and amenities may then be added to each accommodation to ensure a one-of-a-kind, unforgettable experience in each accommodation. The world-class accommodations require experience, dedication, and the highest quality of care. In order to ensure success, like-minded owners may be invited into the accommodation collection, that is, those who appreciate and share a commitment to excellence, down to the smallest details.

According to further embodiments, the classification begins with a process of discovering accommodations which they want to include in the accommodation collection. Upon discovery, invitations may be sent to owners of the discovered accommodations, requesting the owner to send inspectors to examine their accommodation. One or more inspectors then examine the accommodations. Each inspector may use an electronic device, which may include but is not limited to a tablet, a mobile smart phone, or other mobile device to assist with accommodation inspection. If the accommodations meet a certain level of standards set by a pre-determined criterion, it may be given a specific diamond certification. If it does not meet the minimum standards, it will not be given a rating; however, inspectors may provide owners with recommendations which describe how the accommodation could be given a diamond certification in the future.

According to further embodiments, the diamond certifications or ratings, may include: Purple Diamond, Black Diamond, Yellow Diamond, and Green Diamond. A Purple Diamond may be the most prestigious rating. A Purple Diamond may be given to the world's most luxurious and exclusive properties. For example, the Purple Diamond may be given if an accommodation has an extremely unique item, such as, but not limited to, unique architecture and a bowling alley. A Black Diamond may be the second most prestigious rating. A Black Diamond may be awarded to opulent properties for the sophisticated traveler. A Yellow Diamond may be the third most prestigious rating. A Yellow Diamond may be awarded to properties which are carefully curated and include first-class accommodations. A Green Diamond may be given to cutting-edge sustainable properties for the socially conscious traveler. An accommodation may be given multiple diamonds as well.

According to some further embodiments, the present disclosure includes an exclusive club, which may be named “Owner's Circle.” The exclusive club may be only open to owners of properties within the accommodation collection. As members of the exclusive club, owners may have access to exclusive events, special opportunities with brand partners, priority access and reduced pricing on stays within the collection.

Further, the accommodations in the accommodation collection may feature luxurious designer furnishings and décor, unparalleled amenities, and some very special exclusive surprises. Only the crème-de-la-crème make the cut to be part of a global collection, which prides themselves on providing complete guest satisfaction. Full refunds may be provided to those who are not 100% delighted with their experience.

According to some embodiments, one objective of the present disclosure is to help others and hope to set a new standard of generosity. With this, the managers of the system may contribute a percentage of each nightly room rate booked to a cause or a foundation; for example, the Make-A-Wish® foundation.

According to some embodiments, a rating and classification system for vacation rentals is disclosed. The system may be applied to many other settings, situations, and scenarios.

According to further embodiments, the managers of the disclosed system may use travel butlers. The travel butlers perform a plurality of tasks, such as helping travelers plan their trip, customize their itinerary, answer questions, and book unforgettable activities. Once travelers are on the site of their selected accommodation, travel butlers may greet them, provide accommodation tours, and remain on call to assist an any way possible. With this, travel butlers may be employed to stock accommodation with various shopping items or even having a dream car waiting in the driveway upon arrival. Travel butlers may also provide grocery deliveries, personal shopping, setting up a personal chef or event catering, secure necessary staff for the residence, book helicopter tours, limousine services or exotic car rentals, facilitate procurement yachts, jet skis, fishing boats, private jet charters, and more. Travel butlers may function as an inspector or representative who reaches out to newly or previously discovered accommodation owner.

According to further embodiments, a software application may facilitate communication between travel butler and guests. The travel butler may make reservations through business side of application. This includes creating itinerary through guest requests. Guests can request for groceries and flowers. Further, the application may ask questions to guests in order to provide recommendations for guests. The application may learn behavior of the guests. Further, the application may provide a daily calendar to the guests and the travel butlers. Moreover, the application may give notifications or alerts on reservations. After a guest leaves, the application may send them a follow up survey.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates an exemplary environment in which embodiments of the present disclosure may be implemented.

FIG. 2 illustrates a block diagram of a system of ranking an accommodation in accordance with some embodiments.

FIG. 3 depicts an inspector clicking a photograph of a room of an accommodation in accordance with some embodiments.

FIG. 4 illustrates a flowchart of a method of ranking an accommodation in accordance with some embodiments.

FIG. 5 illustrates an exemplary computing system that may be employed to implement processing functionality for various embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of ranking accommodations, embodiments of the present disclosure are not limited to use only in this context. For example, the disclosed techniques may be used to rank other items that are given out for rent or sale.

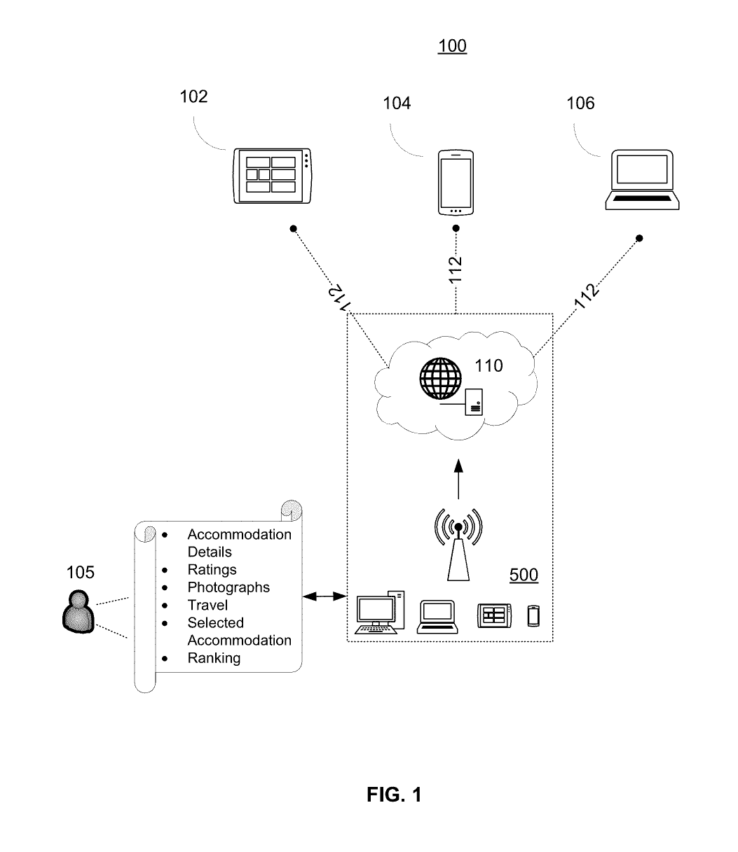

FIG. 1 is an illustration of a platform consistent with various embodiments of the present disclosure. By way of non-limiting example, the online platform 100 for ranking an accommodation may be hosted on a centralized server 110, such as, for example, a cloud computing service. The centralized server 110 may communicate with other network entities, such as, for example, a mobile device (such as a smartphone, a laptop, a tablet computer etc.) and other electronic devices (such as desktop computers, etc.) over a communication network 112, such as, but not limited to, the Internet. Further, users of the platform may include one or more relevant parties such as, owners or managers of accommodations, renters of accommodations and inspectors of accommodations. The accomodations may include one or more residential accomodations (furnished apartments and houses), official accomodations, holiday homes, and resort condominiums. Accordingly, electronic devices operated by the one or more relevant parties may be in communication with the platform. For example, the platform may be in communication with a renter electronic device 102 operated by the renter, an owner electronic device 104 operated by the owner and an inspector electronic device 106 operated by the inspector.

A user 105, such as the one or more relevant parties, may access platform 100 through a software application. The software application may be embodied as, for example, but not be limited to, a website, a web application, a desktop application, and a mobile application compatible with a computing device 500. Accordingly, in an instance, the user 105 may be an owner who may provide information about their accommodation, an inspector who may provide rating for the accommodation against various parameters and photographs of the accommodation, a renter who may provide their travel plan and select an accommodation.

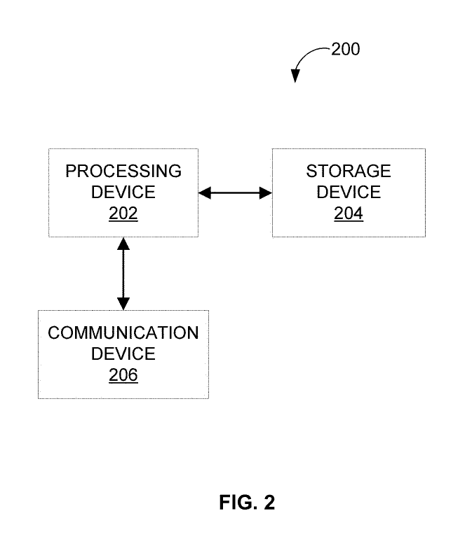

Turning to FIG. 2, a system 200 for ranking an accommodation is illustrated, in accordance with some embodiments. As shown, the system 200 includes a communication device 202, a processing device 204 and a storage device 206.

The communication device 202 may be configured to receive an identifier associated with the accommodation. Further, communication device 202 may be configured to receive multiple object identifiers corresponding to multiple objects comprised in the accommodation. For example, the multiple objects may include furnishing objects, such as, but not limited to, furniture, art work, bedding sheets, mattress, flooring materials, woodwork, custom built-ins, fixtures, custom vanities, sink, door knobs, windows, faucets, kitchen cabinets, kitchen stove, counter top surfaces, decorative accent pieces, dishware, towel bars, toilet paper dispensers, shower system, doors, lighting system, blind system. Further, the multiple objects may include electrical appliances such as, but not limited to, sound systems, video surveillance, security system, television, Internet, telephone and refrigerator.

Yet further, the communication device 202 may be configured to receive one or more values corresponding to one or more attributes associated with each object of the multiple objects. For example, the one or more attributes may include one or more of a brand, a model, a designer, a value, a quantity, a size, a quality, a condition, an age and a material. For example, the one or more values may be received from a database.

The processing device 204 may be configured to analyze the one or more values. Further, the processing device 204 may be configured to generate a rank associated with the accommodation based on the analyzing of the one or more values.

According to some embodiments, the communication device 202 may be further configured to receive an indication of one or more facilities associated with the accommodation, wherein the processing device 204 may be further configured to generate the rank further based on the indication of one or more facilities. The one or more facilities may include one or more of a water front, bowling alley, a heliport, a jet runway, an indoor pool, an outdoor pool, a movie theater, a tennis court, garages, landscape, outdoor kitchen, indoor and outdoor Jacuzzi, hot tubs, steam room, sauna, and gym.

According to some embodiments, the communication device 202 may be further configured to receive a credential of one or more of an architect and a builder associated with the accommodation, wherein the processing device 204 may be configured to generate the rank further based on the credential.

The storage device 206 may be configured to store each of the rank and the identifier associated with the accommodation.

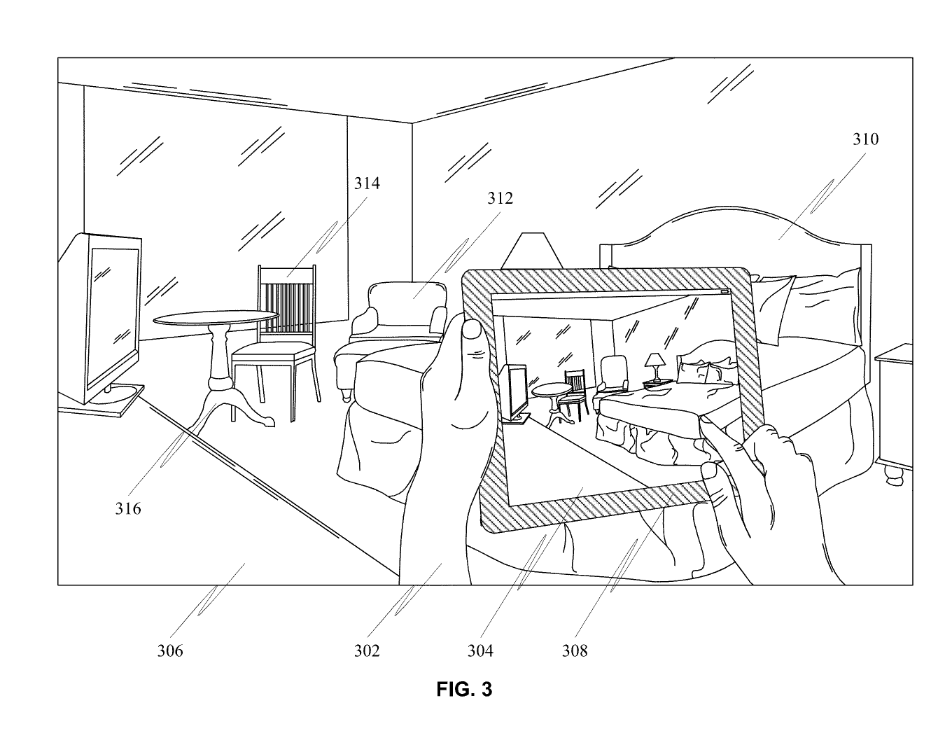

FIG. 3 depicts an inspector 302 clicking a photograph 304 of a room 306 of an accommodation in accordance with some embodiments. The inspector 302 may use a device 308 (similar to inspector electronic device 106), such as, but not limited to, a smartphone, a tablet, and a camera to click the photograph. Further, the inspector 302 may use a software application installed on the device 308 to click the photograph 304. Alternatively, one or more of inspectors, travel butlers, owners and representatives may click the photograph of the accommodation using the software application.

The communication device 202 may be further configured to receive the photograph 304 of the room 306. The photograph 304 captures one or more objects of the multiple objects in the room 306. For example, the one or more objects may include a bed 310, a sofa 312, a chair 314 and a table 316.

The processing device 204 may be further configured to analyze the photograph 304 and recognize the one or more objects based on the analyzing of the photograph 304. Moreover, the processing device 204 may be configured to retrieve the one or more values corresponding to the one or more objects from a database based on the recognizing, wherein the database is configured to store multiple object identifiers and one or more attribute-value pairs associated with each of the multiple object identifiers. Alternatively, the processing device 204 may be further configured to detect the one or more values corresponding to the one or more objects based on the analyzing of the photograph 304. Therefore, there is no need for accessing a database of object identifiers and attribute-value pairs.

Further, the one or more values corresponding to the one or more objects may be displayed on the device 308. Further, descriptive information about the one or more objects may also be displayed. Thereafter, the processing device 204 may generate a rank associated with the accommodation based on the analyzing of the one or more values. For example, the processing device 204 may provide a diamond certification based on the rank.

Thereafter, a renter may access the communication device 202 using the renter electronic device 102 to view a list of available accommodations. The renter may access the communication device 202 via one or both of a web browser and a software application; for example, a smartphone application. Accordingly, the communication device 202 transmits, using the processing device 204, each of the identifier and the rank associated with one or more accommodations to the renter electronic device 102. The renter electronic device 102 may be configured to present (and display) each of the identifier and the rank.

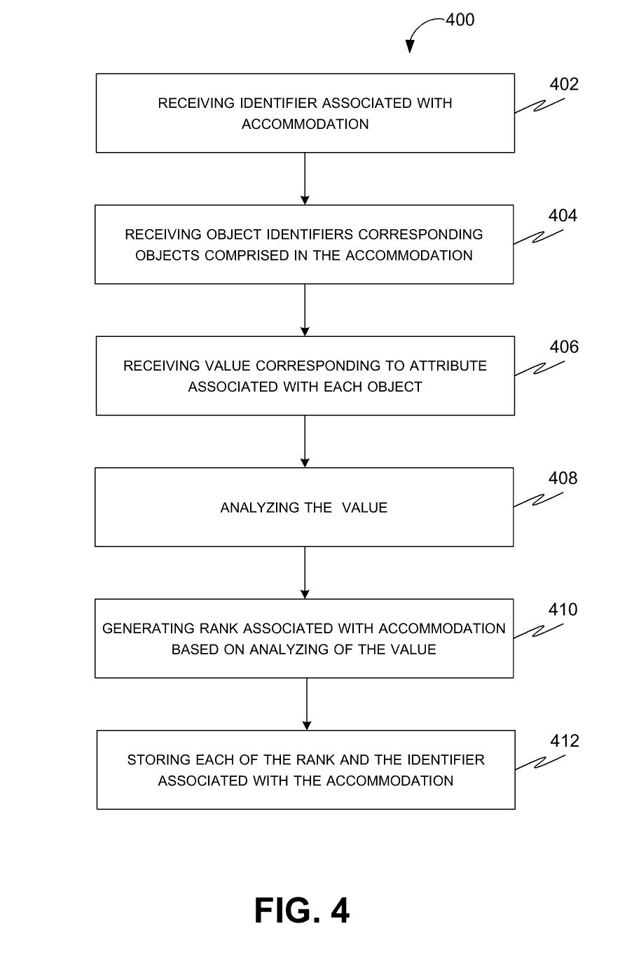

FIG. 4 illustrates a flowchart of a method 400 of ranking an accommodation, in accordance with some embodiments. At 402, the method 400 includes receiving, using a processor (such as the processing device 204), an identifier associated with the accommodation. At 404, the method 400 includes receiving, using the processor, multiple object identifiers corresponding to multiple objects comprised in the accommodation. The multiple objects may include multiple furnishing objects such as, but not limited to, furniture, art work, bedding sheets, mattress, flooring materials, woodwork, custom built-ins, fixtures, custom vanities, sink, door knobs, windows, faucets, kitchen cabinets, kitchen stove, counter top surfaces, decorative accent pieces, dishware, towel bars, toilet paper dispensers, shower system, doors, lighting system, blind system. Further, the multiple objects may include multiple electrical appliances such as, but not limited to, sound systems, video surveillance, security system, television, and refrigerator.

At 406, the method 400 includes receiving, using the processor, one or more values corresponding to one or more attributes associated with each object of multiple objects. For example, the one or more attributes may include one or more of a brand, a model, a designer, a value, a quantity, a size, a quality, a condition, an age and a material. For example, the one or more values may be received from a database.

At 408, the method 400 includes analyzing, using the processor, the one or more values.

At 410, the method 400 includes generating, using the processor, a rank associated with the accommodation based on the analyzing of the one or more values.

The method 400 may also include receiving, using the processor, an indication of one or more facilities associated with the accommodation, wherein generating the rank (at 410) is further based on the indication of one or more facilities. The one or more facilities may include one or more of a bowling alley, a heliport, a jet runway, an indoor pool, an outdoor pool, a movie theater, a tennis court, garages, landscape, outdoor kitchen, indoor and outdoor Jacuzzi, hot tubs, steam room, sauna, and gym.

The method 400 may also include receiving, using the processor, a credential of one or both of an architect and a builder associated with the accommodation, wherein generating the rank (at 410) is further based on the credential.

At 412, the method 400 includes storing, using a storage device (such as the storage device 206), each of the rank and the identifier associated with the accommodation.

According to some embodiments, the method 400 further includes receiving, using the processor, one or more images corresponding to the accommodation, wherein the one or more images captures one or more objects of the multiple objects. For example, one or more images may include the photograph 304 of the room 306 and the one or more objects may include the bed 310, the sofa 312, the chair 314 and the table 316. Accordingly, the method 400 further includes analyzing, using the processor, the one or more images. Further, the method 400 includes recognizing, using the processor, at one or more objects based on the analyzing of the one or more images. Moreover, the method 400 includes retrieving, using the processor, the one or more values (at 406) corresponding to the one or more objects from a database based on the recognizing. The database is configured to store multiple object identifiers and one or more attribute-value pairs associated with each of the multiple object identifiers.

Alternatively, the method 400 includes receiving, using the processor, one or more images corresponding to the accommodation, wherein the at one or more images captures one or more objects of the multiple objects. Accordingly, the method 400 further includes analyzing, using the processor, the one or more images. Moreover, the method 400 includes detecting, using the processor, the one or more values (at 406) corresponding to the one or more objects based on the analyzing.

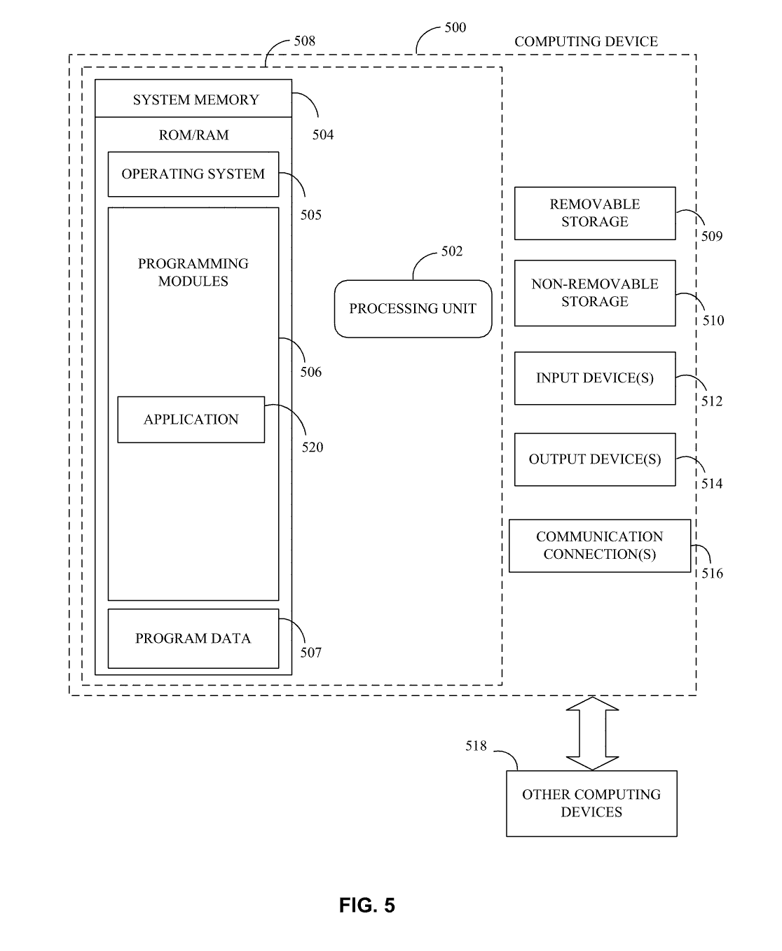

FIG. 5 is a block diagram of a system including computing device 500. Consistent with an embodiment of the disclosure, the aforementioned memory storage and processing unit may be implemented in a computing device, such as computing device 500 of FIG. 5. Any suitable combination of hardware, software, or firmware may be used to implement the memory storage and processing unit. For example, the memory storage and processing unit may be implemented with computing device 500 or any of other computing devices 518, in combination with computing device 500. The aforementioned system, device, and processors are examples and other systems, devices, and processors may comprise the aforementioned memory storage and processing unit, consistent with embodiments of the disclosure.

With reference to FIG. 5, a system consistent with an embodiment of the disclosure may include a computing device or cloud service, such as computing device 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination. System memory 504 may include operating system 505, one or more programming modules 506, and may include a program data 507. Operating system 505, for example, may be suitable for controlling computing device 500's operation. In one embodiment, programming modules 506 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 5 by those components within a dashed line 508.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computer storage media may include volatile and nonvolatile, removable and non-removable media implemented in any method or technology for storage of information, such as computer-readable instructions, data structures, program modules, or other data. System memory 504, removable storage 509, and non-removable storage 510 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a touch input device, etc. Output device(s) 514 such as a display, speakers, a printer, etc. may also be included. The aforementioned devices are examples and others may be used.

Computing device 500 may also contain a communication connection 516 that may allow device 500 to communicate with other computing devices 518, such as over a network in a distributed computing environment, for example, an intranet or the Internet. Communication connection 516 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 504, including operating system 505. While executing on processing unit 502, programming modules 506 (e.g., application 520) may perform processes including, for example, one or more stages of method 400 as described above. The aforementioned process is an example, and processing unit 502 may perform other processes. Other programming modules that may be used in accordance with embodiments of the present disclosure may include image encoding applications, machine learning application, image classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

### DETAIL DESCRIPTIONS OF THE EMBODIMENTS

A method of ranking an accommodation is provided. The method may include receiving, using a processor, an identifier associated with the accommodation. Further, the method may include receiving, using the processor, a plurality of object identifiers corresponding to a plurality of objects comprised in the accommodation. Further, the method may include receiving, using the processor, at least one value corresponding to at least one attribute associated with each object of the plurality of objects. Further, the method may include analyzing, using the processor, the at least one value. Further, the method may include generating, using the processor, a rank associated with the accommodation based on the analyzing of the at least one value. Further, the method may include storing, using a storage device, each of the rank and the identifier associated with the accommodation.

In some embodiments, the plurality of objects may include a plurality of furnishing objects.

In some embodiments, the plurality of objects may include a plurality of electrical appliances.

In some embodiments, the at least one attribute may include one or more of a brand, a model, a designer, a value, a quantity, a size, a quality, a condition, an age and a material.

In some embodiments, the method may further include receiving, using the processor, an indication of at least one facility associated with the accommodation. Further, generating the rank may be further based on the indication of at least one facility.

In some embodiments, the method may further include receiving, using the processor, a credential of one or more of an architect and a builder associated with the accommodation. Further, generating the rank may be further based on the credential.

In some embodiments, the at least one value may be received from a database.

In some embodiments, the method may further include: receiving, using the processor, at least one image corresponding to the accommodation. Further, the at least one image captures at least one object of the plurality of objects; analyzing, using the processor, the at least one image; recognizing, using the processor, at least one object based on the analyzing of the at least one image; retrieving, using the processor, the at least one value corresponding to the at least one object from a database based on the recognizing. Further, the database may be configured to store a plurality of object identifiers and at least one attribute-value pair associated with each of the plurality of object identifiers.

In some embodiments, the method may further include: receiving, using the processor, at least one image corresponding to the accommodation. Further, the at least one image captures at least one object of the plurality of objects; analyzing, using the processor, the at least one image; and detecting, using the processor, the at least one value corresponding to the at least one object based on the analyzing.

In some embodiments, the method may further include presenting, using the processor, each of the identifier associated with the accommodation and the rank.

Further, a system for ranking an accommodation is provided. The system may include a communication device configured to receive an identifier associated with the accommodation. Further, the communication device may be configured to receive a plurality of object identifiers corresponding to a plurality of objects comprised in the accommodation. Further, the communication device may be configured to receive at least one value corresponding to at least one attribute associated with each object of the plurality of objects. Further, the system may include a processing device configured to analyze the at least one value. Further, the processing device may be configured to generate a rank associated with the accommodation based on the analyzing of the at least one value. Further, the system may include a storage device configured to store each of the rank and the identifier associated with the accommodation.

In some embodiments, the plurality of objects may include a plurality of furnishing objects.

In some embodiments, the plurality of objects may include a plurality of electrical appliances.

In some embodiments, the at least one attribute may include one or more of a brand, a model, a designer, a value, a quantity, a size, a quality, a condition, an age and a material.

In some embodiments, the communication device may be further configured to receive an indication of at least one facility associated with the accommodation. Further, the processing device may be configured to generate the rank further based on the indication of at least one facility.

In some embodiments, the communication device may be further configured to receive a credential of one or more of an architect and a builder associated with the accommodation. Further, the processing device may be configured to generate the rank further based on the credential.

In some embodiments, the at least one value may be received from a database.

In some embodiments, the communication device may be further configured to receive at least one image corresponding to the accommodation. Further, the at least one image captures at least one object of the plurality of objects. Further, the processing device may be further configured to: analyze the at least one image; and recognize at least one object based on the analyzing of the at least one image; retrieve the at least one value corresponding to the at least one object from a database based on the recognizing. Further, the database may be configured to store a plurality of object identifiers and at least one attribute-value pair associated with each of the plurality of object identifiers.

In some embodiments, the communication device may be further configured to receive at least one image corresponding to the accommodation. Further, the at least one image captures at least one object of the plurality of objects. Further, the processing device may be further configured to: analyze at least one image, and detect the at least one value corresponding to the at least one object based on the analyzing of the at least one image.

In some embodiments, the system may further include transmitting, using the processor, each of the identifier associated with the accommodation and the rank to a user device. Further, the user device may be configured to present each of the identifier and the rank.

I/We claim:

1. A method of ranking an accommodation, the method comprising:
receiving, using a processor, an identifier associated with the accommodation;
receiving, using the processor, a plurality of object identifiers corresponding to a plurality of objects comprised in the accommodation;
receiving, using the processor, at least one value corresponding to at least one attribute associated with each object of the plurality of objects;
analyzing, using the processor, the at least one value;
generating, using the processor, a rank associated with the accommodation based on the analyzing of the at least one value; and
storing, using a storage device, each of the rank and the identifier associated with the accommodation.

2. The method of claim 1, wherein the plurality of objects comprises a plurality of furnishing objects.

3. The method of claim 1, wherein the plurality of objects comprises a plurality of electrical appliances.

4. The method of claim 1, wherein the at least one attribute comprises at least one of a brand, a model, a designer, a value, a quantity, a size, a quality, a condition, an age and a material.

5. The method of claim 1 further comprising receiving, using the processor, indication of at least one facility associated with the accommodation, wherein generating the rank is further based on the indication of at least one facility.

6. The method of claim 1 further comprising receiving, using the processor, a credential of at least one of an architect and a builder associated with the accommodation, wherein generating the rank is further based on the credential.

7. The method of claim 1, wherein the at least one value is received from a database.

8. The method of claim 1 further comprising:
receiving, using the processor, at least one image corresponding to the accommodation, wherein the at least one image captures at least one object of the plurality of objects;
analyzing, using the processor, the at least one image;
recognizing, using the processor, at least one object based on the analyzing of the at least one image;
retrieving, using the processor, the at least one value corresponding to the at least one object from a database based on the recognizing, wherein the database is configured to store a plurality of object identifiers and at least one attribute-value pair associated with each of the plurality of object identifiers.

9. The method of claim 1 further comprising:
receiving, using the processor, at least one image corresponding to the accommodation, wherein the at least one image captures at least one object of the plurality of objects;
analyzing, using the processor, the at least one image; and
detecting, using the processor, the at least one value corresponding to the at least one object based on the analyzing.

10. The method of claim 1 further comprising presenting, using the processor, each of the identifier associated with the accomodation and the rank.

11. A system for ranking an accommodation, the system comprising:
a communication device configured to:
receive an identifier associated with the accommodation;
receive a plurality of object identifiers corresponding to a plurality of objects comprised in the accommodation;
receive at least one value corresponding to at least one attribute associated with each object of the plurality of objects;
a processing device configured to:
analyze the at least one value;
generate a rank associated with the accommodation based on the analyzing of the at least one value; and
a storage device configured to store each of the rank and the identifier associated with the accommodation.

12. The system of claim 11, wherein the plurality of objects comprises a plurality of furnishing objects.

13. The system of claim 11, wherein the plurality of objects comprises a plurality of electrical appliances.

14. The system of claim 11, wherein the at least one attribute comprises at least one of a brand, a model, a designer, a value, a quantity, a size, a quality, a condition, an age and a material.

15. The system of claim 11, wherein the communication device is further configured to receive indication of at least one facility associated with the accommodation, wherein the processing device is configured to generate the rank further based on the indication of at least one facility.

16. The system of claim 11, wherein the communication device is further configured to receive a credential of at least one of an architect and a builder associated with the accommodation, wherein wherein the processing device is configured to generate the rank further based on the credential.

17. The system of claim 11, wherein the at least one value is received from a database.

18. The system of claim 11, wherein the communication device is further configuerd to receive at least one image corresponding to the accommodation, wherein the at least one image captures at least one object of the plurality of objects, wherein the processing device is further configured to:
analyze the at least one image; and
recognize at least one object based on the analyzing of the at least one image;
retrieve the at least one value corresponding to the at least one object from a database based on the recognizing, wherein the database is configured to store a plurality of object identifiers and at least one attribute-value pair associated with each of the plurality of object identifiers.

19. The system of claim 11, wherein the communication device is further configuerd to receive at least one image corresponding to the accommodation, wherein the at least one image captures at least one object of the plurality of objects, wherein the processing device is further configured to:
analyze at least one image; and
detect the at least one value corresponding to the at least one object based on the
analyzing of the at least one image.

20. The system of claim 11 further comprising transmitting, using the processor, each of the identifier associated with the accomodation and the rank to a user device, wherein the user device is configured to present each of the identifier and the rank.
